(19) United States
(12) Patent Application Publication
(10) Pub. No.: US 2007/0171644 A1
(43) Pub. Date: Jul. 26, 2007

(54) Apparatus for Decorating Support Columns in Changing Environments

(75) Inventor: Robert Rhea Seibel, Waretown, NJ (US)

Correspondence Address: Robert R. Seibel, 154 Lighthouse Drive, Waretown, NJ, 08758, US

(73) Assignee: POLEPANTS, LLC, Waretown, NJ (US)

(21) Appl. No.: 11/307,067

(22) Filed: Jan. 20, 2006

(51) Int. Cl. F21V 21/00

(52) U.S. Cl. 362/249

(57) ABSTRACT

Strong, fire-retardant material is constructed in such a way as to wrap around metal and non-metal, round or square support columns making them more attractive and environmentally pleasing. The material is especially made to wrap around vertical or horizontal poles such as deck poles and house pilings but is not limited to these applications. Strong nylon tie straps and Velcro strips attach the material firmly to the support column. These methods allow the material to be easily removed and another material color or image installed. The material is made to accommodate a range of pole diameters thus allowing one size to fit many pole circumferences. The material may be embellished with digital print images, light strips, overhead light assemblies, solid colors, striped colors, ascending bubbles complementing the material's images and top-mounted craft assemblies. These craft assemblies wrap around and attach to the pole to compliment the appropriate material design. Craft assemblies may include but are not limited to bird nests, light strands simulating a lighthouse beacon and flower baskets. Said material may also be attached to special hollow columns simulating solid poles allowing more decorative lighting designs.

### FIELD OF INVENTION

This invention describes how to decoratively cover any type of round or square support column changing its appearance to meet environmental, seasonal and personal needs. Described is specially constructed material to cover both wooden and non-wooden support columns creating both an environmentally pleasing and artistic appearance. The material is made to be easily installed and removed from round, square or irregular poles, pilings and other support columns especially when columns vary in circumference. One constructed material size is designed to fit a wide range of pole circumferences. The material can be covered with solid colors, striped patterns and digitally printed images. In addition, embellishments to the material is further described to create additional visual effects on the material. Finally, this invention describes how to create additional visual effects by shining light downward through a hollow column wrapped with said material.

### BACKGROUND OF INVENTION

Today's business and housing construction codes require the use of strong wooden, metal or concrete support columns to sufficiently support the weight of today's construction materials. These internal and external columns are typically made of material not visually attractive or environmentally pleasing. New outdoor-treated lumber is green then ages to a gray, mildew color. Metal poles turn to rusty steel and aluminum is gray looking. Concrete is gray and filled with gravel. A better way is needed to cover these poles with a material that is easy to install, lasts for years, is water-proof, sun-proof, fire-resistant and can be changed as the environment or seasons change. All prior art uses complex, expensive construction methods to cover poles. Not all solutions are for indoor and outdoor use. None describe the use of additional methods to further enhance the pole covering. This invention addresses all of the shortcomings to create a new, easy to install way of covering and enhancing both outdoor and indoor support columns.

### PRIOR ART

An examination of prior art shows many inherent problems and complex solutions all of which are solved by this invention. Referenced below are US patents compared to this invention.

U.S. Pat. No. 5,067,547—Complex and expensive construction. Complex rings are needed to create a pole to attach the fabric. Describes the creation of a pole but does not use an existing pole. Material can not be easily removed or changed. Not suited for outdoor use where strong wind, rain, sun elements are constant. No additional visual effects can be simply added to further enhance the material.

U.S. Pat. Nos. 5,553,433, 4,912,901, 4,961,258, 5,271,878, 5,335,471, 5,568,709, 5,899,044, 6,061,939, 6,148,565, 6,622,451, 6,639,571—Complex and expensive construction. Complex frame needs to be created to attach to pole. Special supports are needed to attach the frame to the pole. Not suited for outdoor use where strong wind, rain, sun elements are constant. No additional visual effects are described. Can not be easily removed or changed. Can not be adjusted to fit different pole diameters.

U.S. Pat. Nos. 4,606,167, 6,192,646—Complex and expensive construction. Complex frame needs to be created to attach fabric to pole. Special frames have to be made to attach to the pole. Not suited for outdoor use where strong wind, rain, sun elements are constant. No additional visual effects are described. Only for I-Frame steel columns. Can not be easily removed or changed. Can not be adjusted to fit different pole sizes. A new apparatus must be made for each size.

U.S. Pat. No. 5,853,167—Complex and expensive construction. Only describes the cap assembly and not the entire pole design. No visual enhancements described or discussion on how they might be attached. Does not describe a light fixture to shine on the pole.

U.S. Pat. No. 6,260,328—Used only to protect lumber. Not designed for changing the covering. Covering can not be easily removed or changed for seasons or environments. No accommodations to add visual effects. Completely different application.

U.S. Pat. No. 6,363,644—Not suited for outdoor use where strong wind, rain, sun elements are constant. No additional visual effects described. Can not be easily removed or changed. Describes totem-pole fixed design.

### SUMMARY OF INVENTION

This invention embodies three ways to provide decorative coverings to support columns of metal, wooden and concrete poles, either round or square. The first embodiment describes material to easily attach to round or square support columns. The material is made to fit varying pole circumferences. The material is made from strong, flame-retardant material such as Ferrari Textiles PRECONTRAINT® fabric, Ferrari Stamoid® textiles or Glen-Raven's Sunbrella Firesist® fabric. These are only representative materials. This invention does not preclude the use of other fabrics. The material is then looped at the ends and sewn at the top and bottom to create a pocket for a nylon or similar cable tie strap. One nylon strap goes through the loop at the top and one at the bottom. The ends then connect to each other as it is wrapped around the pole. To keep the material closed in the middle, three Velcro strips are also sewn to the material at specified location such that when the “hook” and “loop” Velcro strips are mated, the Velcro strips close the middle section of the material. Once attached, the Velcro strips are mostly hidden depending on the circumference of the pole. The fabric may be made from solid colors, stripes or have digital images printed on it. Since the material is made this way, the material may be removed at will and replaced with another differently designed material. This facilitates changing the exterior design of the support column to meet the changing environment like Spring, Fall, Summer, Winter or for religious holidays, or to compliment any occasion like birthdays, family pictures or animal pictures. The material design allows this wide range of flexibility. The Velcro attachment design uniquely accommodates varying pole circumferences. Of special note is that Velcro is an illustrative attachment method example and does preclude using other attachment methods such as glue, staples, buttons or snaps.

The second embodiment deals with adding visual effects to the material. The visual effects are constructed in such a way as to easily attach to the material. The visual effects enhance the image on the material. The visual effects described use electricity but are not limited to electrical enhancements. As an example, a craft ornament such as a plastic birds nest can be strapped around the top of the pole enhancing the visual effect on the material.

The third embellishment is wrapping the material with or without visual effects around a hollow, lighted column so light shines from inside the column outward through the material. This hollow column need not be wrapped around the pole but, itself, simulate a pole. This hollow column can be used along with other wrapped poles to create an overall desired effect. This invention does not preclude placing the hollow column around a solid support column.

### BRIEF DESCRIPTION OF DRAWINGS

FIG. 1 shows the formulas used to calculate the circumference of a round or square poles and then the added adjustments necessary for the Velcro® attachment tabs.

FIG. 2 shows the assembled material made in such a way as to wrap around varying pole diameters and then is firmly attach to the pole.

FIG. 3 shows how the material is attached to the pole using the Velcro tabs. Placement of the tabs on the material is unique to this invention since it allows for varying pole circumferences without wasting material or exposing the pole itself.

FIG. 4 shows the two Velcro tabs in relation to one another for small pole circumferences.

FIG. 5 shows the two Velcro tabs in relation to one another for larger pole circumferences. This arrangement makes sure the pole is always covered with material regardless of pole circumference.

FIG. 6 shows the attachment of a string of lights to the material to further enhance the image on the material.

FIG. 7 shows how the light string is made and attached to the material.

FIG. 8 shows the attachment of a bubble generation assembly to the material to further visually compliment the image on the material.

FIG. 9 shows the bubble generation system assembly in more detail and how said system is attached to the said material.

FIG. 10 shows the spot light assembled on to a frosted, hollow column which illuminates the inside of the column allowing light to shine through the material to further enhance the material's image.

FIG. 11 shows the light assembly mounted to the top of the hollow column and shining downward to the bottom of the column.

### DETAILED DESCRIPTION OF INVENTION

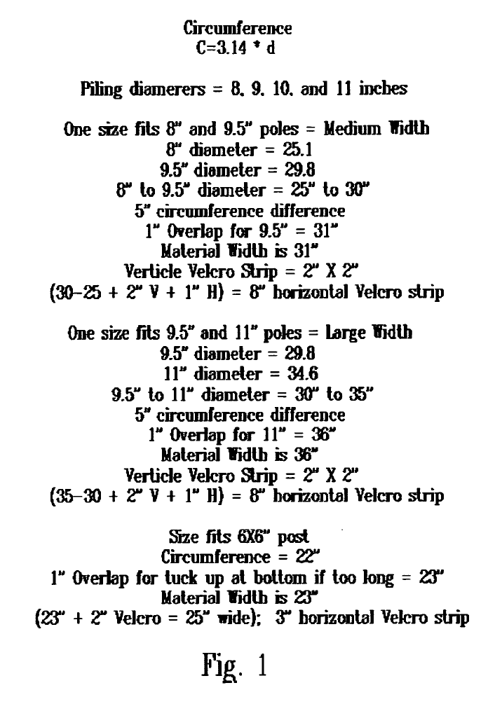

The width 2 of the material to wrap around the pole is determined by calculating the circumference of the poles being covered. FIG. 1 shows the formulas. One material size is made to fit a range of pole circumferences. The Velcro tabs are designed to expand or contract to the actual pole circumference. FIG. 1 shows for a pole in the circumference range of 25″ to 30″, 2″ has to be added to account for the width of the left vertical Velcro tab. It's important to note that the vertical tab is attached on the image side and the right horizontal side is attached to the side without the image (the opposite material surface). This allows the two Velcro tabs to mate as the material is overlapped. Since the smallest circumference is 25″, a longer horizontal tab sewn on the opposite side will be needed to wrap around the pole and also mate with the 2″ vertical Velcro tab. Even though these calculations are for specific pole circumferences, the formula can be applied to smaller or larger pole circumferences. This design allows for one size material with described Velcro assembly to always cover poles that are 25″ to 30″ in circumference. This is only an example. The formula may be applied to any pole circumference. The formulas also show the material size and Velcro placement for square fixed circumference poles.

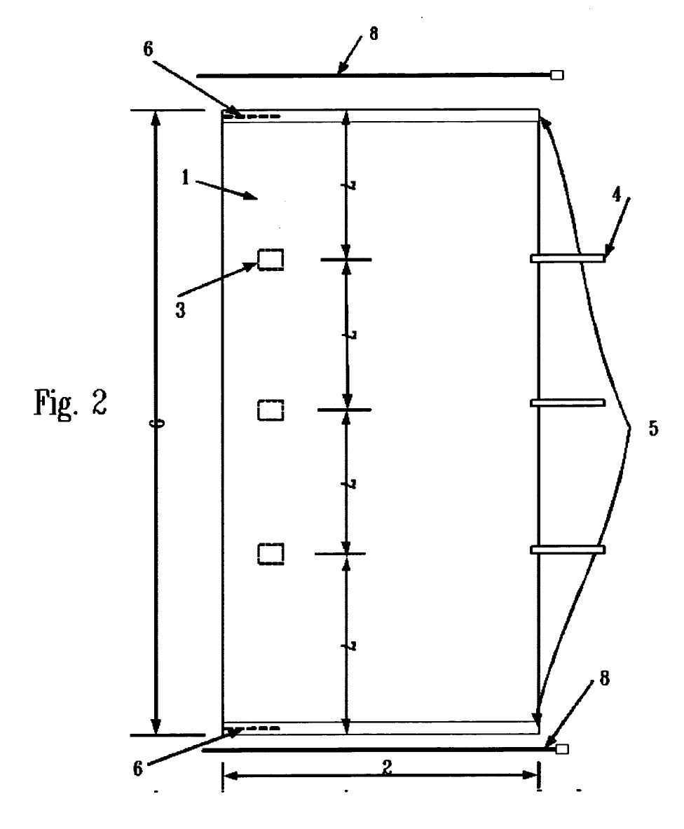

FIG. 2 shows the assembled material 1 with the Velcro tabs 3 and 4 and the loops 5 sewn at the top and bottom. The loops 5 are made by sewing the material back on itself. Velcro tab 3 is sewn to mate with the horizontal Velcro tab 4. The left vertical tab is sewn offset from the edge allowing the material to expand and still cover larger size poles. It's important to note that the offset is determined by:
(1) Subtracting the difference between the small size and large size
(2) Then adding to that any desired material overlap
(3) Then subtracting the left Velcro tab width
(4) This is the distance from the edge of the material to the left edge of the left Velcro tab.

Tab 3 is sewn on the image side of the material. Tab 4 is sewn on the opposite, non-image side. This allows the material to overlap at the joint for full contact with tab 3. The material's width 2 is determined by the calculations in FIG. 1. The material's height is determined by the height of the pole. If the pole is shorter than the material's length, the excess material is tucked under at the bottom and then strapped to the pole. Bottom loop 5 and the nylon strap 8 is folded up and on the inside of the material hiding the excess material and the nylon strap. Nylon strap 8 ensures the material will firmly stay attached to the pole in all kinds of weather. Velcro tabs 3 and 4 are evenly separated apart at 25% intervals 7 of the material's length. Of special note is slot 6 needed in the material's top and bottom loop. This slot is made on the printed side to accommodate the nylon strap adjusting to smaller poles. Tightening the strap on the material will not cause the material at the top and bottom to become compressed and cause an unsightly appearance. The overlapping material covers the excess material on smaller circumference poles.

The present invention in the illustrative embodiments solves many problems stated earlier in Prior Art.
(1) There are no complex brackets, rings, assemblies to attach the material to the pole. Velcro strips and nylon cable ties are used instead. This Invention is not limited to only these simple fasteners. Buttons, snaps or glue can be used as well.
(2) The material can be easily installed by the home owner and easily replaced with another material having a different color, striped pattern or printed image. The Velcro tabs simply needs to be separated and the nylon straps cut and replaced with new ones. Its simple design helps ensure long life.
(3) The material is made from inherently flame-retardant fibers and does not need to be treated externally with flame-retardant chemicals yearly. Material is used that complies with the National Fire Codes.
(4) Nylon straps provide a strong attachment to the pole and are weather proof.
(5) The entire design in made for indoor or outdoor use and is water-proof, wind-proof and sun-proof.
(6) The material is made from UV-resistant colors and inks. No fading will occur when used outdoors for many years.
(7) One size is made to fit a variety of sizes. Many fixed sizes are not needed as described in Prior Art.

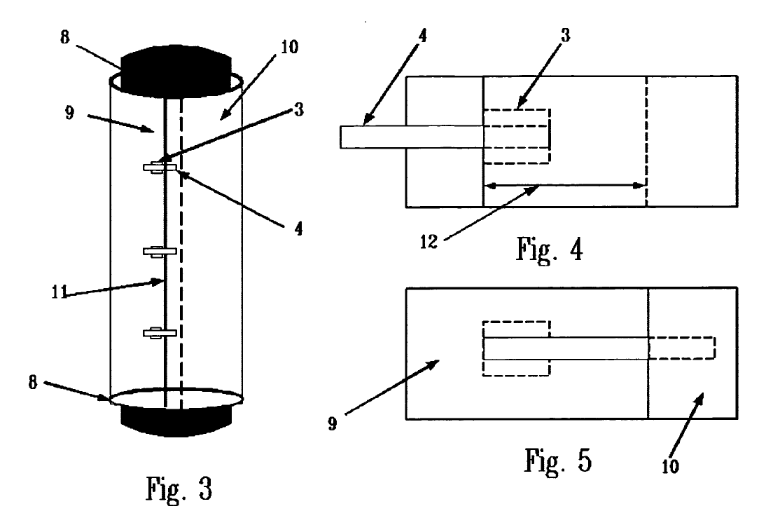

FIG. 3 shows the assembled material 1 with the top and bottom nylon straps 8 pulled together and the Velcro tabs 3 and 4 contacting each other in the middle section to keep the material firmly closed. The material's outward side 9 has the vertical Velcro strip 3 attached and mates with the horizontal Velcro tab 4 attached to the opposite surface of the material. The nylon tie straps 8 ensure the material is firmly attached to the pole.

FIG. 4 shows how the material contracts to cover smaller pole circumferences. The excess tab 4 is simply tucked into the material overlap. Distance 12 is the material's surplus material needed to accommodate different support column circumferences.

FIG. 5 shows how the material expands to cover larger pole circumferences. In this example, the entire horizontal Velcro tab length is used allowing the material to expand to its maximum length and still cover the support column completely.

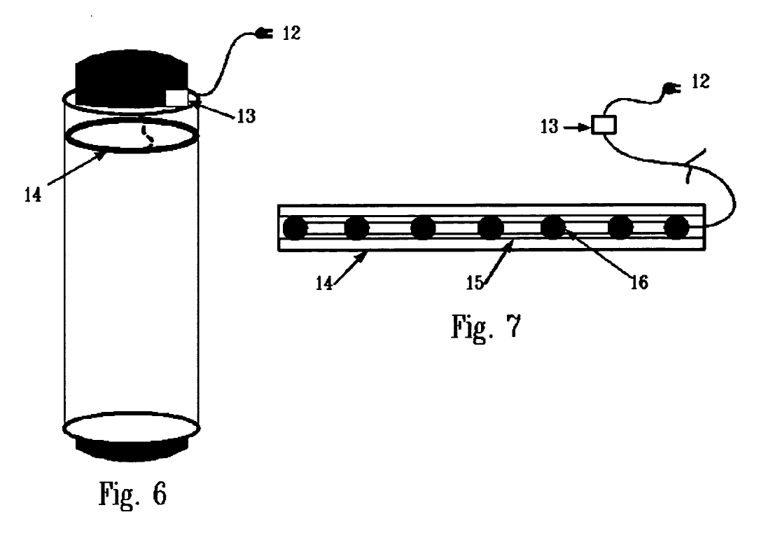

The second embodiment of this invention includes adding visual effects to the material thus enhancing the image on the material. The first visual effects are lighting strips. FIG. 6 shows one way to attach a lighting strip to the material. Since the lighting strips 14 are flexible, they can be attached to the material 1 and wrapped around the pole and power 12 applied. A power converter 13 with an optional blinker circuit is used to power the lights. Light sources such as Light Emitting Diodes (LEDS) and incandescent lights are described in this invention but the invention is not limited to such sources. Light strips may be placed at various angles on the material 1 as well to enhance the visual effect.

FIG. 7 shows such a light strip. Such example light strips 15 are made by Platinum Lighting of Las Vegas, Nev. This company makes many different color LEDs 16 like white, green, orange, red, yellow and blue. What is unique is the use of a clear, plastic sheath 14 to attach the light strip 15 to the material. The clear sheath 14 is attached to the material 1. The light strip 15 is then inserted into the sheath 14 firmly attaching it to the material. The power converter 13 and cord is then located above the pole, out-of-sight of the viewer. The power cord is placed on the inside of the fabric keeping it out-of-sight as well. Said clear plastic sheath is attached by sewing, gluing, heat bonding, stapling to said material. These attachment methods do not preclude using other attachment methods.

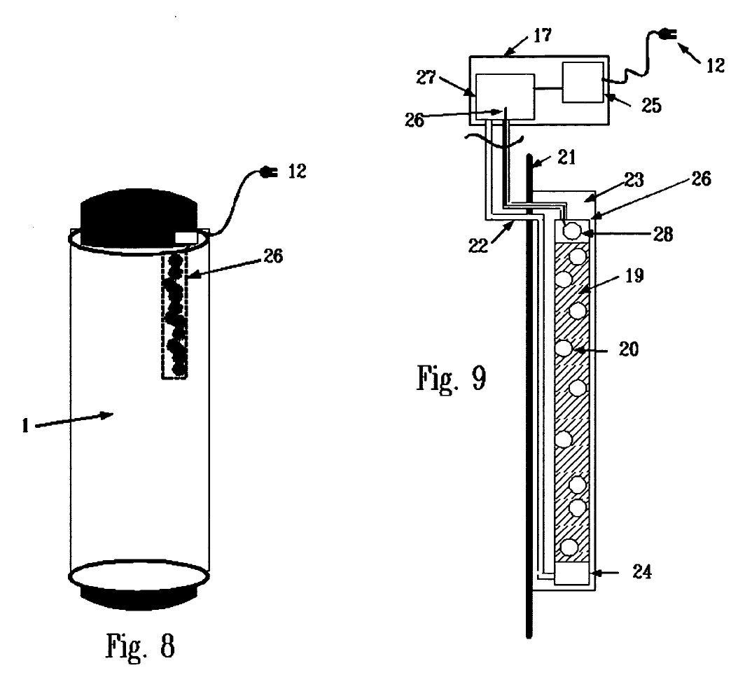

The second visual enhancement described is a bubble tube 26. A bubble tube adds to the visual effect printed on the material 1. Such an effect would be used to show bubbles coming from a SCUBA diver, fish, shipwrecks and similar images printed onto the material. FIG. 8 shows the bubble tube positioned vertically on the material 1. In the same fashion as lights, the bubble tube is attached to the material using a clear plastic sheath 23 attached to the material. The bubble tube is placed into the clear plastic sheath. The sheath is attached to the material 1 by sewing, gluing, heat bonding or stapling. This invention does not preclude other attachment methods.

FIG. 9 shows the bubble tube in detail. A clear plastic tube 19 contains a clear fluid having anti-freeze properties. The bottom end of the tube 24 has a cap allowing compressed air into the bottom to create the bubbles. It also seals the liquid into the tube. The top cap 26 seals the liquid into the tube and also collects the air from the bubbles and channels it to the air compressor 27 using plastic tubing 22. The end cap also has a light source 28 shining downward to illuminate the bubbles as they percolate upward. A compressed air tube 22 delivers the compressed air to the bottom of the bubble tube. A power transformer 25 converts the incoming power to the power needed by the air compressor 27 and the light 28. The power transformer 25 supplies the air compressor with power. The air compressor 27 also channels the power 26 needed for the light 28 through the return air tubing so power is provided to the light source in the upper end cap. It is important to note that the bubble tube is contained in a clear plastic sheath 23 attached to the material 21. The air supplies 22 to the tube 19 is placed out-of-site behind the fabric. The supply box 17 is also placed above the material out-of-sight.

The addition of visual enhancements is not described by prior-art. The present invention in the illustrative embodiments provides numerous improvements:
(1) Visual enhancements are attached to the material using clear plastic sheaths sewn to the material. Other attachment methods are included in this invention like using staples, snaps, glue, heat bonding, rope and other type fasteners.
(2) Visual enhancements are contained in a water-proof sheath to withstand outdoor elements.
(3) Low power light sources like LEDs are used but are not limited to in this invention.
(4) Bubble tubes are used to enhance visual effects printed on the material. This invention does not limit visual effects to only these two. Others like plastic bird nests, advertising props, model cars, trains, and many others can be attached using nylon straps around the pole.

The third embodiment of this invention is the use of a hollow tube simulating a pole. The hollow tube is made to support said material and the visual embellishments described herein. The tube may have holes cut 33 into it allowing visual embellishments to recess into the hollow tube to further enhance the visual effects. The tube may be frosted to evenly disseminate light from an internal light source located inside the pole.

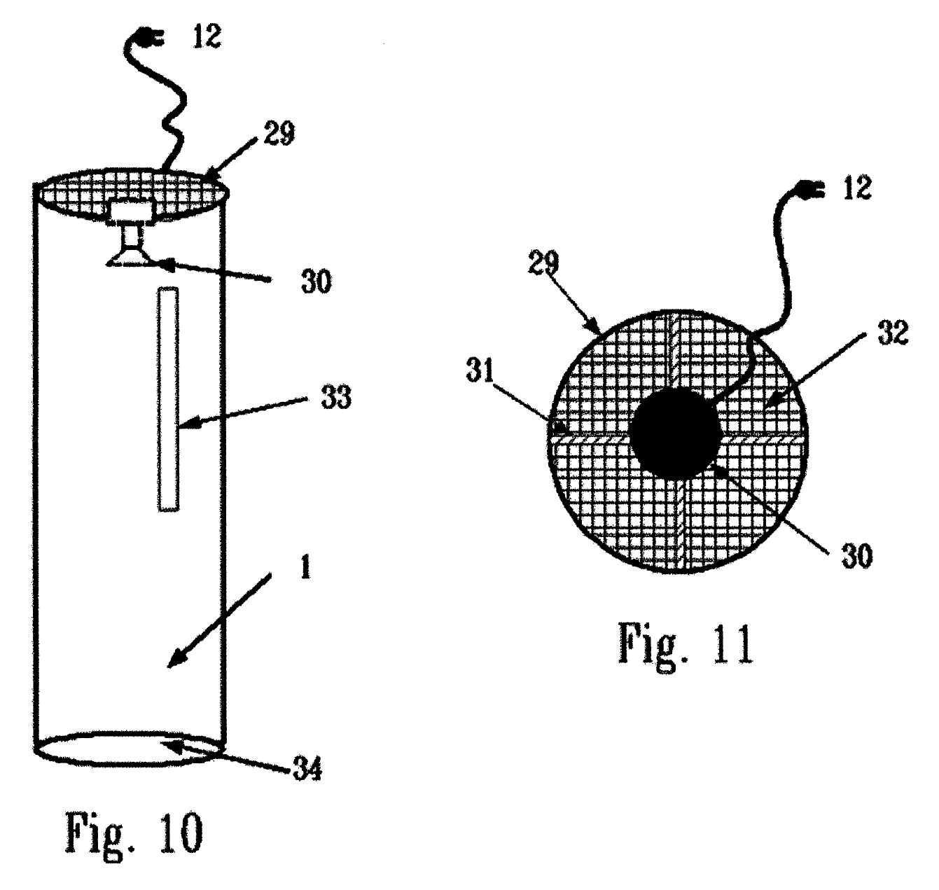

FIG. 10 shows a power source 12 connecting to a light assembly 30 shining downward into the hollow tube 34. The tube may be frosted to better disseminate the light outward through the material further enhancing the material's color or image. The hollow tube 34 may have slots 33 cut into its sides allowing visual enhancements to be recessed into the tube. The top of the tube has a solid cover 32 with vent slots preventing the light from shining upward onto unwanted surfaces causing a visual distraction to the image on the material. Vents are used to allow heat from the light source to escape and not build up in the hollow tube.

FIG. 11 shows the top view of the hollow column 34. The top light cap 32 is supported to the column by brackets 31 that overhang the column's side. The brackets 31 overhang the top of the column and attach into the column's side. The power source 12 attaches to the light assembly 30 and then attaches to the light source. The light source is not limited to a single light but may be made up of many circular LEDS or small incandescent strings of light.

The present invention in the illustrative embodiments is superior to Prior Art because:
(1) The physical pole does not limit the placement of visual effects.
(2) The visual effects may be easily placed into a hollow tube emulating a pole.
(3) The whole design is simple, lacking complex rings and other assemblies used in Prior Art. It can be safely used indoors or outdoors in all types of weather since all components are weather and water-proof.

It should again be emphasized that the above described materials, attachments, light and bubble embellishments are illustrative only. Thus, it is to be appreciated that the particular materials, attachments and embellishments and other features shown in the figures are presented by way of example only and should not be viewed as requirements of this invention. For example, alternative embodiments may use different materials, attachment methods, light elements, bubble elements and hollow tube materials other than those of the illustrative embodiments. These and numerous other alternative embodiments within the scope of the following claims will be apparent to those skilled in the art,

What is claimed is:

1. An apparatus for use in covering round, square or irregular shaped poles, supports or beams comprising a special, simple, fireproof, weatherproof, strong material used to cover said support columns of varying circumferences; wherein said material is decorated with solid, striped colors or have printed images applied to said material.

2. The apparatus in claim 1 wherein said material may be constructed with transparent, opaque, mesh, cut-proof fabric.

3. The apparatus in claim 1 and 2 wherein multiple attachment methods strategically spaced allowing easy attachment or detachment to/from support columns;
wherein attachment methods lengths and widths are made in such a way to allow one material width to be firmly attached to poles of varying circumferences without the need to have many material sizes.

4. The apparatus in claim 1 and 2 wherein is further enhanced to provide loops at the material's top and bottom allowing attachment methods to be inserted into the loops. The attachment methods are then pulled tightly around the pole firmly attaching said material to the support or decorative column.

5. The apparatus in claim 1 and 2 wherein accommodates for varying support column circumferences using one designed apparatus.

6. An apparatus wherein the attachment to said support column at the top and bottom is slotted to accommodate said material covering poles of different circumferences;
wherein said slot prevents material from bunching together at the point of overlap.

7. An apparatus wherein the attachment to said support column other than at the ends accommodates fastening material to itself wherein material is firmly joined without excess material being used or material not covering said support column completely.

8. The apparatus in claim 1 and 2 wherein is further enhanced with lighting methods adding to the image, color or striping on said material; wherein light assemblies may be placed at any angle and may be wrapped around said material or on a particular portion of said material.

9. An apparatus wherein a bubble tube is constructed to attach to apparatus in claim 1 and 2; wherein apparatus is comprised of an electrical power source and an air source all connected to the bubble tube by flexible tubing; wherein a light source is integrated into the top air collection chamber allowing for bubble illumination; wherein power to the light source is integrated into the air collection system; wherein bubble tube is filled with freeze-proof liquid allowing it to be used outdoors.

10. The apparatus in claim 8 and 9 wherein flexible sheaths attached to said material for the purpose of attaching embellishment to claim 1 and 2 apparatus.

11. An apparatus wherein hollow tube is constructed in such a way to light said material in claim 1 and 2 from the inside out; wherein hollow tube may be frosted allowing even light distribution through said material in claim 1 and 2.

12. The apparatus in claim 11 is further enhanced wherein a light cap is so constructed to attach to the top of the hollow column to shine light downward and outward through said material; wherein the top is made to vent light source heat and yet keep light from escaping out.
